(19) United States
(12) Patent Application Publication
(10) Pub. No.: US 2013/0037277 A1
(43) Pub. Date: Feb. 14, 2013

(54) Foam Generating Apparatus

(71) Applicant: Darren Sean Henry, Williamston, SC (US)

(72) Inventor: Darren Sean Henry, Williamston, SC (US)

(21) Appl. No.: 13/209,356

(22) Filed: Aug. 12, 2011

(51) Int. Cl. A62C 35/00; E03C 1/08

(52) U.S. Cl. 169/14; 239/428.5

(57) ABSTRACT

This invention is directed to a foam generating apparatus having a mixing chamber housing inside a tank; a fluid injection head inside the mixing chamber housing for receiving the foaming agent traveling along an initial flow direction; a flow spoiler included in the fluid injection head for changing the initial flow direction of the foaming agent entering the fluid injection head; a first mixing chamber; a plurality of fluid ports included in the fluid injection head allowing foaming agent to exit the fluid injection head and enter the first mixing chamber thereby creating an intermediate foam in the first mixing chamber; a gas port allowing pressurized gas to mix with the intermediate foam generating output foam.

### FIELD OF THE INVENTION

This invention is directed to a foaming apparatus and more specifically, a foaming apparatus that generates intermediate foam and output foam.

### BACKGROUND OF THE INVENTION

Foam generation is useful for several diverse applications when a foaming agent or surfactant is mixed with a gas to create gas bubbles in the surfactant to generate foam. Applications include the fields of firefighting, cleaning, cosmetics, recreation, medical and aesthetics.

For example, in firefighting, foam can be used for fire suppression. Foam cools the fire and coats the fuel thereby preventing the fuel from continued contact with oxygen resulting in fire suppression. There are several types of foams. Class A foams lower the surface tension of the water which assists in the wetting and saturation of Class A fuels with water. Class B foams are designed for fires fueled by flammable liquids. Class B foams include aqueous film forming foams and are water-based, frequently contain hydrocarbon-based surfactant such as sodium alkyl sulfate, and contain fluorosurfactants such as fluorotelomers, perfluorooctanoic acid (PFOA), or perfluorooctanesulfonic acid (PFOS). Protein foams contain natural proteins as the foaming agents. Unlike synthetic foams, protein foams are bio-degradable. In the firefighting industry, low-expansion foams generally have an expansion rate less than 20 times. Foams with expansion ratio between 20-200 are generally described as medium expansion. High-expansion foams generally have an expansion ratio over 200.

With each type of foam for firefighting, however, there is a need to generate foam from a foaming agent.

There are two main types of fire extinguishers: stored pressure and cartridge-operated. In stored pressure units, the expellant is stored in the same chamber as the firefighting agent itself. Depending on the agent used, different propellants are used. Stored pressure fire extinguishers are the most common type.

With dry chemical extinguishers, nitrogen is typically used; water and foam extinguishers typically use air. Cartridge-operated extinguishers contain the expellant gas in a separate cartridge that is punctured prior to discharge, exposing the propellant to the extinguishing agent. The released expellant gas expands, filling the gas space above the dry chemical. This pressurizes the cylinder and forces the dry chemical up through a pipe and out through a hose or nozzle to be directed upon the fire. Cartridge-operated extinguishers are not as common, used primarily in areas such as industrial facilities, where they receive higher-than-average use.

One of the most popular fire extinguishers is based on sodium bicarbonate and used for Class B and C fires. In the heat of a fire, it releases a cloud of carbon dioxide that smothers the fire. That is the gas drives oxygen away from the fire, thus stopping the chemical reaction. However, sodium bicarbonate is much less effective than wet chemical agents for Class K fires.

Wet Chemical (potassium acetate, carbonate, or citrate) is preferred for Class K fires as it extinguishes the fire by forming a soapy foam blanket over the burning oil and by cooling the oil below its ignition temperature. Detergent based additives used in wet chemical extinguishers can break the surface tension of water and improve penetration of Class A fires. Misting nozzles can be included as those used on water mist units to give these extinguishers Class B and C firefighting capability. Various approaches to water misting nozzles are disclosed in U.S. Pat. Nos. 5,839,667 and 5,505,383, each of which are incorporated by reference.

When fighting a fire, the expansion rate of the foaming agent is a critical component to determining the size of the fire that can be extinguished and the operational time of the fire extinguisher. For example, a typical residential fire extinguisher commercially available lasts between 10 to 20 seconds when discharged. For a water extinguisher, it can last up to a minute. Therefore, providing the maximum amount of extinguishing material in this short period of time is critical.

When using foaming agents, the expansion ratio of the foaming agent to the foam is a contributing factor to the amount of extinguishing material and effectiveness of the extinguisher. There have been attempts to increase the expansion ratio so that the maximum amount of effective foam can be produced from a fire extinguisher. For example, U.S. Pat. No. 5,058,809 is representative of a foam generating nozzle designed to aspirate ambient air into a flowing aqueous stream containing a foam producing agent. U.S. Pat. No. 2,106,043 discloses a method for generating foam in which a non-combustible gas is mixed with an aqueous foam forming mixture in a foam forming chamber. However, none of these references are particularly well suited for handheld residential fire extinguishers.

Foam generation is also useful for cosmetic applications. For example, shaving cream is a substance that is applied to the face or wherever else hair grows, to provide lubrication and avoid razor burn during shaving. Shaving cream is often bought in a spray can which dispenses foam. The shaving cream itself commonly consists of a mixture of oil, soaps, surfactants, and water or alcohol. Currently, the shaving cream is a post-release gel which foams only after it exits the spray can. The shaving cream contained in the spray can is not expended and, therefore, typically results in the overuse of the gel by the user.

In the medical field, foam has several applications including being used as an adjunct in the sealing of abdominal parenchymal tissues (liver and spleen) when stopping bleeding by ligature or conventional methods is ineffective or impractical. The foam creates a mechanical barrier to decrease blood flow and pores for the blood to enter, leading to cellular aggregation and enhanced hemostasis. Typically, the foam is produced by mixing solutions of protein and a cross-linker which generates foam through a chemical reaction. This method, while resulting in foam, is costly and less effective than that of other foam generation methods. Further, this liquid is initially an adhesive and subsequently sets as soft foam.

In the construction industry, foam is used for insulation as well as sealing undesired openings in structures during construction and for repairing openings in existing structures. However, one drawback is that the foam, once it enters the nozzle of the spray can or application tube, hardens in the nozzle or application tube. The undesired result is that the foaming agent typically can only be used once.

In the manufacturing industry, foam can be used for a large number of purposes from the actual manufacturing process itself such as in the marine industry when foam in used to fill spaces in a marine vessel to making prototypes. Some of these products include foam cup holders, footwear, armrests, headrests, camera cases, seat cushions, toilet bowl seats, kneeling and knee pads and padding for backpacks. Expanding foam can be molded by spraying some into a plastic bag, sealing it, and then pressing an item into the foam so that it becomes form-fitted thereby creating a reverse image of the molded product.

It is an object of this invention to provide for a foam generator for use with a tank or cylinder to generate foam.

It is another object of this invention to provide for a foam generator for use with a tank or cylinder that is hand held and can increase expansion using a pressurized gas contained within the tank or cylinder.

### SUMMARY OF THE INVENTION

The objects of the invention are accomplished by providing a foam generating apparatus comprising: a tank containing a foaming agent and a pressurized gas; a tank valve carried by the tank for providing a tank opening in the tank when the tank valve is in an open position; a mixing chamber housing disposed inside the tank in fluid communications with the tank valve; a fluid injection head disposed inside the mixing chamber housing for receiving the foaming agent traveling along an initial flow direction; a flow spoiler included in the fluid injection head for changing the initial flow direction of the foaming agent entering the fluid injection head; a first mixing chamber defined between the mixing chamber housing and the fluid injection head; a plurality of fluid ports included in the fluid injection head allowing foaming agent to exit the fluid injection head and enter the first mixing chamber thereby creating an intermediate foam in the first mixing chamber; a gas port included in the mixing chamber disposed downstream of the fluid injection head and in fluid communications with the interior of the tank allowing pressurized gas to mix with the intermediate foam generating output foam; and, whereas the foaming agent is forced into the mixing chamber housing and the fluid injection head by the pressurized gas when the tank valve is in an open position resulting in the expulsion of output foam from the tank.

The invention can also include a snorkel carried by the mixing chamber housing. The foaming agent can be a surfactant used for applications taken from the group consisting of firefighting, cosmetics, medical, manufacturing and construction. A filter 74 can be carried by the mixing chamber housing for preventing contaminates from entering the mixing chamber housing.

An impact surface disposed on the interior of the mixing chamber wherein the fluid agent entering the mixing chamber impacts the impact surface creating turbulence to assist in generating intermediate foam. The impact surface can be a rough surface having a roughness value greater than 1.0 μm.

In one embodiment, the gas port can be arranged to have a gas travel path angle less than 90° to the initial flow direction. In one embodiment the gas port can be in line with initial flow direction.

A fluid flow regulator for restricting the amount of foaming agent that may enter the fluid injection head and can include an external curved shoulder.

The ratio between the area of a cross-section of the fluid injection head and the area of a cross-section of the mixing chamber is in a range of 1:1.5 and 1:20.0.

The tank or cylinder can include a hose in fluid communications with the opening in the tank; a nozzle attached to the hose for directing the output foam in a particular direction; and, a pressure gauge for measuring the pressure of pressurized gas in the tank.

A refill port can be included for refilling the tank with pressurized gas after the pressurized gas is depleted. A tank valve assembly can be included wherein the mixing chamber housing is attached to the tank valve assembly. A burst disk carried by the tank for preventing over pressurization of the tank can be included in the tank valve assembly. The pressurized gas can be nitrogen.

### DESCRIPTION OF THE DRAWINGS

The invention will be more readily understood from a reading of the following specification and by reference to the accompanying drawings forming a part thereof, wherein an example of the invention is shown and wherein:

FIGS. 1A and 1B are perspectives of the invention;

FIG. 2 is a perspective of the invention;

FIG. 3 is a perspective of the invention;

FIG. 4 is a perspective of the invention; and,

FIG. 5 is a perspective of the invention.

### DESCRIPTION OF A PREFERRED EMBODIMENT

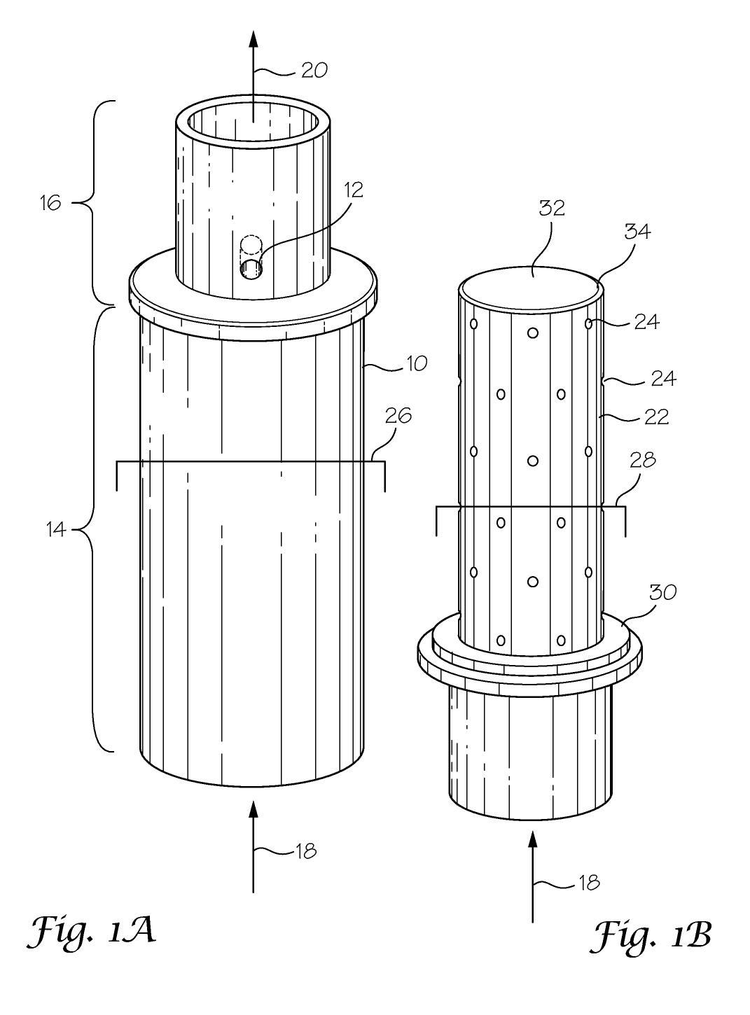

Referring to FIG. 1A, mixing chamber housing 10 is shown. Gas port 12 is shown defined in the mixing chamber housing allowing gas to flow between the exterior of the mixing chamber housing and the interior of the mixing chamber housing. The mixing chamber housing can define a first mixing chamber 14 and a second mixing chamber 16 wherein the gas port is disposed in the second mixing chamber. Foaming agent can flow into the mixing chamber housing in an initial flow direction 18, be used to generate foam, and exit the mixing chamber housing in an output flow direction 20. In one embodiment, the diameter of a cross-section along plane 26 is between 8.5 cm and 9.5 cm. In one embodiment, the area of a cross-section along plane 26 is approximately 63.5 cm².

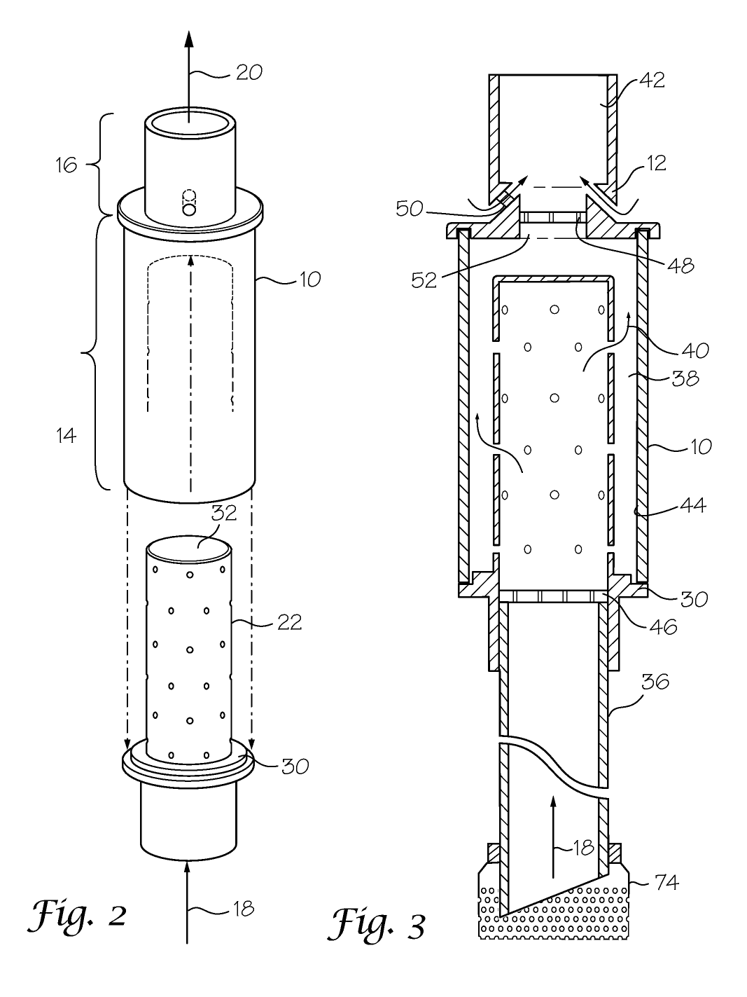

Referring to FIG. 1B, a fluid injection head 22 can include a plurality of fluid ports 24 defined in the fluid injection head. In one embodiment, the fluid ports are arranged to force foaming agent to travel in a path generally perpendicular to the initial flow direction. In one embodiment, the diameter of a cross-section along plane 28 is between 4.0 cm and 5.0 cm. In one embodiment, the area of a cross-section along plane 28 is approximately 12.5 cm². In one embodiment, the ratio between the area of the cross-section taken at plane 28 to the area of the cross-section taken at plane 26 is approximately 1:5. This ratio can be as small as 1:1.5 and exceed 1:20.0. The injection head is received into the mixing chamber housing (FIG. 2) and can be disposed in the first mixing chamber. A fluid injection head seat 30 contacts the mixing chamber housing and prevents fluid agent and foam from exiting mixing chamber housing upstream.

A flow spoiler 32 is attached to the fluid injection head and impedes foaming agent from continued travel in the initial flow direction. The foaming agent, traveling inside the fluid injection head under pressure, encounters the flow spoiler and pressure generated by disrupting the foaming agent flow forces the foaming agent through the fluid ports. In one embodiment, an external curved shoulder 34 is included to facilitate foam traveling externally to the fluid injection port in the first mixing chamber.

In one embodiment, the fluid injection head is affixed to the mixing chamber housing.

Referring to FIG. 3, a cross-section of the invention is shown. A snorkel can be included to provide a travel path for the foaming agent to travel into the fluid injection head. As shown, foaming agent travels in initial flow direction 18 into the fluid injection port. The foaming agent is then forced through the fluid ports. This action creates turbulence and causes the foaming agent to foam into the first mixing chamber 38. Intermediate foam is produced and flows in a direction shown as 40 toward a second mixing chamber 42. When ejected through the fluid ports, foaming agent can impact surface 44 disposed on the inner wall of the mixing chamber housing. In one embodiment, the impact surface is a rough surface. The surface can have a roughness value of 1.0 μm or greater. By way of example, flame cutting provides a cut surface having a roughness value between 6.3 μm and 50 μm; chemical milling between 0.8 μm and 12.5 μm; barrel finishing between 0.05 μm and 3.2 μm and forging between 1.6 μm and 25 μm as described by ANSI B46.1.

In one embodiment, a fluid flow regulator 46 can be disposed upstream of the first mixing chamber to regulate the amount of foaming agent that enters the fluid injection head. The regulator can be adjusted to increase or decrease the flow level by a fluid flow regulator actuator disposed externally to the tank or cylinder to adjust the flow rate of foaming agent entering the fluid injection head. The fluid flow regulator can be a valve, two planes with openings which, when aligned do not restrict the flow rate when offset, restrict the flow rate and the like. In one embodiment, a secondary flow regulator 48 can be downstream of the fluid injection head, but upstream of the gas port to regulate the amount of intermediate foam entering the second mixing chamber. The secondary regulator can be adjusted to increase or decrease the flow level by a secondary flow regulator actuator disposed externally to the tank or cylinder to adjust the flow rate of intermediate foam entering the second mixing chamber. In one embodiment, a gas flow regulator 50 can be carried by the gas port to regulate the amount of pressurized gas entering the second mixing chamber. The gas regulator can be adjusted to increase or decrease the flow level of pressurized gas. In one embodiment, a restriction area 52 is included at the entrance to the second mixing chamber for restricting the flow of intermediate foam into the second mixing chamber. Output foam mixed with pressurized gas exits the mixing chamber housing in an output flow direction 20.

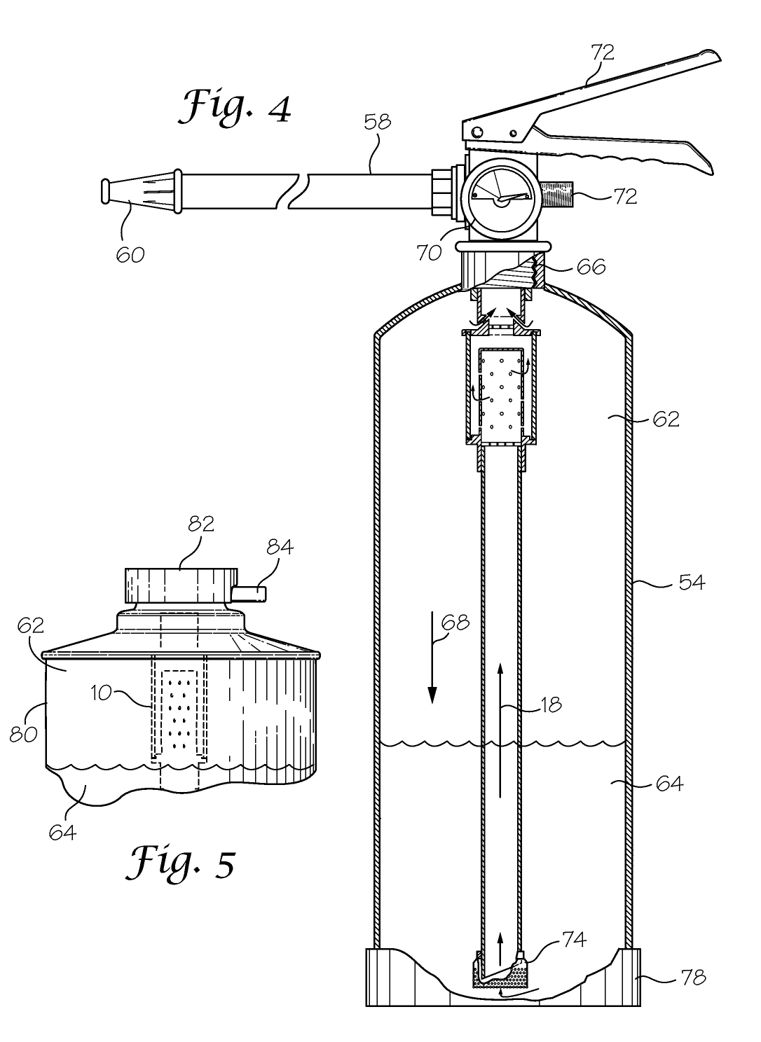

Referring to FIG. 4, tank or cylinder 54 contains pressurized gas 62 and foaming agent 64. A valve assembly 56 is removably attached to the tank at tank opening 66. The mixing chamber housing is in fluid communications with tank opening 66. In one embodiment, the valve assembly includes a male thread and the tank opening includes a female thread to secure the valve assembly to the tank. The valve assembly, when opened, allows the pressurized gas to exert a force in a direction shown as 68 forcing foaming agent in an initial flow direction 18 into the fluid injection head. Intermediate foam generated in the second mixing chamber then flows to the second mixing chamber where pressurized gas is injected into the intermediate foam to further expand the foam. In one embodiment, the pressurized gas is nitrogen.

A hose 58 is attached to the valve assembly to direct the output foam generated in the second mixing chamber. A nozzle 60 is attached to the hose and in one embodiment, can be a misting nozzle. A gauge 70 can be attached to the valve assembly to indicate the pressure (usually measured in PSI in the United States) of the tank. A valve actuator 72, when actuated, opens a valve in the valve assembly and the pressure of the pressurized gas causes the foaming agent to travel into the mixing chamber housing and the output foam to travel through hose and out the nozzle. The tank an also include a boot 78 for protecting an end of the tank or cylinder.

If the pressurized gas is depleted, the foaming agent is depleted or for any other reason the foaming agent or pressurized gas needs to be replenished, the valve assembly can be removed to expose the tank opening. Foaming agent can be placed in the tank and the valve assembly replaced. A refill port, also including a valve, can be used to pressurize the tank with pressurized gas. The tank is then “recharged” for subsequent use.

A filter 74 can be attached to the mixing chamber housing or snorkel for preventing contaminates from entering the fluid injection head that may have been in the foaming agent as preventing contaminates from entering the injection head is advantageous for several reasons.

Referring to FIG. 5, a shaving cream cylinder 80 containing pressurized gas 62 and foaming agent 64 is shown. When actuator 82 is depressed, foam generated inside mixing chamber housing 10 is forced through nozzle 84 for use.

While a preferred embodiment of the invention has been described using specific terms, such description is for illustrative purposes only, and it is to be understood that changes and variations may be made without departing from the spirit or scope of the following claims.

What is claimed is:

1. A foam generating apparatus comprising:
a tank containing a foaming agent and a pressurized gas;
a tank valve carried by said tank for providing a tank opening in said tank when said tank valve is in an open position;
a mixing chamber housing disposed inside said tank in fluid communications with said tank valve;
a fluid injection head disposed inside said mixing chamber housing for receiving said foaming agent traveling along an initial flow direction;
a flow spoiler included in said fluid injection head for changing said initial flow direction of said foaming agent entering said fluid injection head;
a first mixing chamber defined between said mixing chamber housing and said fluid injection head;
a plurality of fluid ports included in said fluid injection head allowing foaming agent to exit said fluid injection head and enter said first mixing chamber thereby creating an intermediate foam in said first mixing chamber;
a gas port included in said mixing chamber disposed downstream of said fluid injection head and in fluid communications with the interior of said tank allowing pressurized gas to mix with said intermediate foam generating output foam; and,
whereas said foaming agent is forced into said mixing chamber housing and said fluid injection head by said pressurized gas when said tank valve is in an open position resulting in the expulsion of output foam from said tank.

2. The apparatus of claim 1 including a snorkel carried by said mixing chamber housing.

3. The apparatus of claim 1 wherein said foaming agent is a surfactant used for applications taken from the group consisting of firefighting, cosmetics, medical, manufacturing and construction.

4. The apparatus of claim 1 including a filter carried by said mixing chamber housing for preventing contaminates from entering said mixing chamber housing.

5. The apparatus of claim 1 including an impact surface disposed on the interior of said mixing chamber wherein said fluid agent entering said mixing chamber impacts said impact surface creating turbulence to assist in generating intermediate foam.

6. The apparatus of claim 5 wherein said impact surface is a rough surface.

7. The apparatus of claim 6 wherein said impact surface has a roughness value greater than 1.0 μm.

8. The apparatus of claim 1 wherein said fluid ports are arranged generally perpendicular to said initial flow direction.

9. The apparatus of claim 1 wherein said gas port is arranged to have a gas travel path angle less than 90° to said initial flow direction.

10. The apparatus of claim 9 where said gas travel path angle is generally 45°.

11. The apparatus of claim 1 including a fluid flow regulator for restricting the amount of foaming agent that may enter the fluid injection head.

12. The apparatus of claim 1 wherein said flow spoiler includes an external curved shoulder.

13. The apparatus of claim 12 wherein the ratio between the area of a cross-section of said fluid injection head and the area of a cross-section of the mixing chamber is in a range of 1:1.5 and 1:20.0.

14. The apparatus of claim 1 including a gas injection mixing chamber included in said mixing chamber housing arranged downstream of said fluid injection head wherein said pressurized gas is injected in said intermediate foam through said gas port.

15. The apparatus of claim 1 including:
a hose in fluid communications with said opening in said tank;
a nozzle attached to said hose for directing said output foam in a particular direction; and,
a pressure gauge for measuring the pressure of pressurized gas in said tank.

16. The apparatus of claim 15 including an actuator for opening said tank valve.

17. The apparatus of claim 1 including a refill port for refilling said tank with pressurized gas after said pressurized gas is depleted.

18. The apparatus of claim 1 including a tank valve assembly wherein said mixing chamber housing is attached to said tank valve assembly.

19. The apparatus of claim 1 including a burst disk carried by said tank for preventing over pressurization of said tank.

20. The apparatus of claim 1 wherein said pressurized gas is nitrogen.

21. A foaming apparatus for use with a tank, the tank including a tank valve and a tank opening and containing a foaming agent and a pressurized gas comprising:
a mixing chamber housing disposed in said tank and in fluid communications with the tank opening;
a fluid injection head having a plurality of fluid ports and a flow spoiler disposed in said mixing chamber housing;
a first mixing chamber defined by an inner wall of said mixing chamber housing and an outer wall of said fluid injection head for creating intermediate foam when the fluid agent is forced into said fluid injection head by said pressurized gas when said tank valve is open;
a second mixing chamber defined by said mixing chamber housing disposed downstream from said first mixing chamber for receiving intermediate foam;
a gas port defined in said second mixing chamber and in fluid communications with the interior of said tank; and
whereas pressurized gas from said tank is injected into said second mixing chamber and mixed with said intermediate form producing output foam when said tank valve is open.

22. The apparatus of claim 21 including a snorkel carried by said mixing chamber housing for directing foaming agent into said fluid injection head.

23. The apparatus of claim 21 including an impact surface disposed on said interior wall of said mixing chamber wherein said fluid agent entering said mixing chamber impacts said impact surface creating turbulence.

24. The apparatus of claim 21 wherein said fluid ports are arranged generally perpendicular to the initial flow direction of said foaming agent entering said fluid injection head.

25. The apparatus of claim 21 including a fluid flow regulator disposed upstream of said fluid injection head for restricting the amount of foaming agent that may enter the fluid injection head.

26. The apparatus of claim 25 including a fluid flow regulator actuator disposed externally to said tank allowing said fluid flow regulator to adjust the amount of foaming agent that may enter the fluid injection head.

27. The apparatus of claim 21 including a secondary flow regulator disposed downstream of said fluid injection head for restricting the amount of intermediate foam that may enter said second mixing chamber.

28. The apparatus of claim 27 including a secondary flow regulator actuator disposed externally to said tank allowing said secondary flow regulator to adjust the amount of intermediate foam that may enter said second mixing chamber.

29. The apparatus of claim 21 including a gas flow regulator for restricting the amount of pressurized gas that may enter said second mixing chamber.

30. The apparatus of claim 29 including a gas flow regulator actuator disposed externally to said tank allowing said gas flow regulator to adjust the amount of pressurized gas that may enter said second mixing chamber.

31. The apparatus of claim 21 wherein said tank is a fire extinguisher tank.

32. The apparatus of claim 21 wherein said tank is a shaving cream container.

33. A foaming apparatus disposed in a tank having an opening and containing pressurized gas and a foaming agent comprising:
a mixing chamber having a housing;
a fluid injection head disposed in said mixing chamber for receiving foaming agent traveling in an initial flow direction;
a flow spoiler carried by said fluid injection head for directing said foaming agent away from said initial travel path so that said foaming agent travels through a plurality of fluid ports included in said fluid injection head in a direction generally perpendicular to said initial travel path creating intermediate foam; and,
a gas port disposed generally downstream from said redirection surface for injecting pressurized gas into said intermediate foam thereby creating output foam.

34. The apparatus of claim 33 including a redirection surface included in the interior of said mixing chamber housing for redirecting said intermediate foam to an output flow direction.

35. The apparatus of claim 33 including a first impact surface disposed on the interior of said mixing chamber wherein said fluid agent entering said mixing chamber impacts said impact surface creating turbulence assist in generating intermediate foam.

36. The apparatus of claim 33 including a fluid flow regulator for restricting the amount of foaming agent that may enter said fluid injection head.

37. The apparatus of claim 33 including a secondary fluid flow regulator upstream of said gas port for regulating the flow rate of intermediate foam within said mixing chamber.

38. The apparatus of claim 33 including a gas flow regulator for restricting the amount of pressurized gas that may enter said mixing chamber.

39. The apparatus of claim 33 including:
a hose in fluid communications with said opening in said tank; and,
a nozzle attached to said hose for directing said output foam in a particular direction.

40. The apparatus of claim 39 wherein said nozzle is a misting nozzle.
